(19) United States
(12) Patent Application Publication
(10) Pub. No.: US 2007/0180500 A1
(43) Pub. Date: Aug. 2, 2007

(54) Apparatus and system for data exchange

(75) Inventor: Tosaku Tanada, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, TOKYO (JP)

(21) Appl. No.: 11/385,853

(22) Filed: Mar. 21, 2006

(30) Foreign Application Priority Data
Feb. 2, 2006 (JP) 2006-25781

(51) Int. Cl. H04L 9/32

(52) U.S. Cl. 726/4

(57) ABSTRACT

Provided is a data exchange system comprising a client apparatus and a server apparatus, both configured to exchange a plurality of data to each other via a communication network, to establish a first session without authentication if the server apparatus approves a request for the first session from the client apparatus, as the server apparatus stores at most a record of a session canceled no less than a given time ago, to establish a second session after authenticating each other if the server apparatus requests authentication in response to the request for the first session, as the server apparatus stores a record of a session canceled less than a given time ago, to exchange a set of data on the first session after a check if the set of data needs authentication for being exchanged, and on the second session without the check.

### CROSS REFERENCE TO RELATED APPLICATIONS

This application is based upon and claims the benefit of priority from the prior Japanese Patent Application No. 2006-025781 filed on Feb. 2, 2006; the entire contents of which are incorporated herein by reference.

### FIELD OF THE INVENTION

The present invention relates to a client apparatus, a server apparatus and a data exchange system comprising the client apparatus and the server apparatus for data exchange.

### DESCRIPTION OF THE BACKGROUND

There is known a data exchange system formed by a first apparatus configured to request data exchange (hereinafter called a client apparatus) and a second apparatus configured to accept the request (hereinafter called a server apparatus) connected to each other via a communication network. Another one or more client apparatus may join the data exchange system. The client apparatus establishes a session with the server apparatus before exchanging a plurality of data with the server apparatus. The session is canceled after the data has been exchanged.

Before the session is established, the server apparatus authenticates at least one of the client apparatus and a person using the client apparatus (hereinafter this process is called client authentication). The server apparatus determines if the requested data exchange is allowed based on a result of the client authentication. The server apparatus exchanges the data with the client apparatus if the data exchange is allowed. The server apparatus refuses the request if the data exchange is not allowed.

There may be a kind of data requiring no client authentication for being exchanged between the server apparatus and any of the client apparatus of the data exchange system having requested the data exchange. There may be another kind of data requiring the client authentication for being exchanged. A process of the client authentication is useless if the data to be exchanged requires no client authentication. In addition, there may be a case where a server apparatus and an anonymous client apparatus exchange a plurality of data.

A method is disclosed in Japanese Patent Publication (Kokai), No. 2001-62124, by which a server apparatus and a client apparatus establishes a session between each other without authentication, and upon receiving a request for a data set to be exchanged with authentication, the server apparatus starts a process of authentication by sending a request to the client apparatus for an identifier, a password, etc. of the client apparatus.

The above method, however, may have a problem that the server apparatus has to determine if the authentication process is needed upon each request of data exchange, and that a processing load of each of the server apparatus and the client apparatus increases each time the authentication process is needed and run.

### SUMMARY OF THE INVENTION

Accordingly, an advantage of the present invention is that a need of an authentication process upon each request of data exchange may be reduced even if each data set to be exchanged requires authentication.

To achieve the above advantage, one aspect of the present invention is to provide a data exchange system, comprising a client apparatus and a server apparatus, both configured to exchange a plurality of data to each other via a communication network, to establish a first session between each other without authentication in a case where the server apparatus approves a request for the first session sent from the client apparatus, as the server apparatus stores at most a record of a session with the client apparatus canceled no less than a given time ago, to establish a second session between each other after authenticating each other in a case where the server apparatus requests authentication in response to the request for the first session, as the server apparatus stores a record of a session with the client apparatus canceled less than a given time ago, to exchange a set of data between each other on the first session after a check if the set of data needs authentication for being exchanged, and on the second session without the check.

### BRIEF DESCRIPTION OF THE DRAWINGS

FIG. 1 is a block diagram of a data exchange system of the embodiment of the present invention.

FIG. 2 is a bock diagram of a client apparatus of the embodiment of the present invention.

FIG. 3 is a bock diagram of a server apparatus of the embodiment of the present invention.

FIG. 4 is an example of an entry of session history data of the embodiment of the present invention.

FIG. 5 is a flow chart of data exchange managed by a data exchange manager of the client apparatus of the embodiment of the present invention.

FIG. 6 is a flow chart of data exchange managed by a data exchange manager of the server apparatus of the embodiment of the present invention.

FIG. 7 shows a sequence example of data exchange between the client apparatus and the server apparatus of the embodiment of the present invention, followed by FIG. 8.

FIG. 8 shows a sequence example of data exchange between the client apparatus and the server apparatus of the embodiment of the present invention, following FIG. 7.

### DETAILED DESCRIPTION OF THE INVENTION

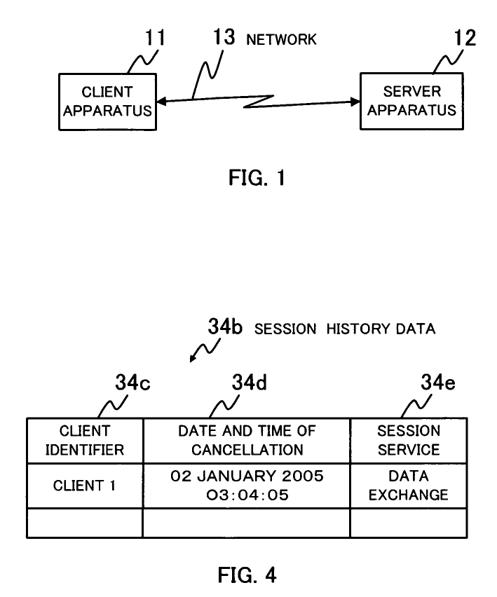

An embodiment of the present invention will be described with reference to FIGS. 1-8. FIG. 1 is a block diagram of a data exchange system formed by a client apparatus 11 and a server apparatus 12 of the embodiment of the present invention. The client apparatus 11 and the server apparatus 12 are connected to each other via a network 13, e.g. a Bluetooth network. The network 13 may be an infrared network, a wireless local area network, a Universal Serial Bus (USB) network, etc.

The data exchange system may include a plurality of client apparatus (not shown) other than the client apparatus 11 and a plurality of server apparatus (not shown) other than the server apparatus 12. The client apparatus 11 may also work as a server, and the server apparatus 12 may also work as a client.

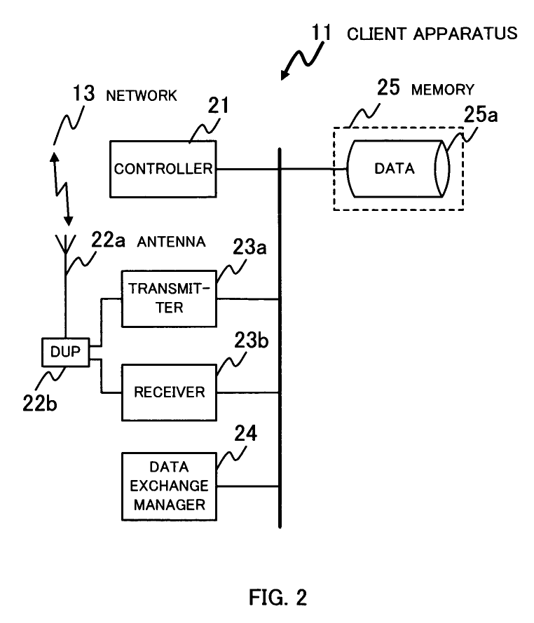

FIG. 2 is a bock diagram of the client apparatus 11, comprising a controller 21, an antenna 22a, a duplexer 22b, a transmitter 23a, a receiver 23b, a data exchange manager 24 and a memory 25. The controller 21 is configured to entirely monitor and control the client apparatus 11. The antenna 22a is configured to send and receive a plurality of radio signals to and from the network 13. The memory 25 stores a plurality of data 25a.

The controller 21 may be formed by a processing device like a microprocessor, a digital signal processor, etc. The data exchange manager 24 may be formed by the same processing device as the controller 21, and may be formed by another processing device.

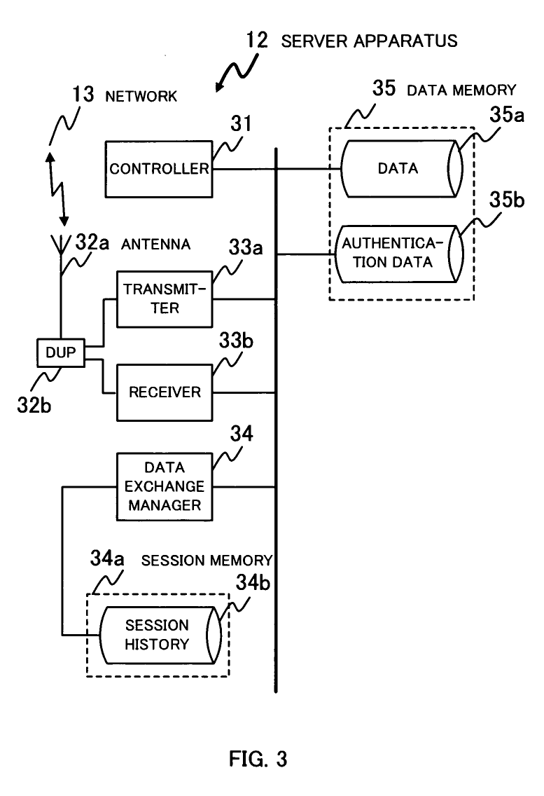

FIG. 3 is a bock diagram of the server apparatus 12, comprising a controller 31, an antenna 32a, a duplexer 32b, a transmitter 33a, a receiver 33b, a data exchange manager 34, a session memory 34a and a data memory 35. The controller 31 is configured to entirely monitor and control the server apparatus 12. The antenna 32a is configured to send and receive a plurality of radio signals to and from the network 13.

The controller 31 may be formed by a processing device like a microprocessor, a digital signal processor, etc. The data exchange manager 34 may be formed by the same processing device as the controller 31, and may be formed by another processing device.

The session memory 34a stores a plurality of data regarding a session history 34b (hereinafter called the session history data 34b). The data memory 35 stores a plurality of data 35a and a set of data regarding authentication for data exchange 35b (hereinafter called the authentication data 35b).

The data 25a may include a data set like a telephone directory, an email folder, etc. The telephone directory includes a phone number, an email address, and a name of at least one person. The email folder includes at least one transmitted email and at least one received email in a case where the client apparatus 11 is capable of sending and receiving emails.

The data 35a may include a data set like a telephone directory, an email folder, etc. The telephone directory includes a phone number, an email address, and a name of at least one person. The email folder includes at least one transmitted email and at least one received email in a case where the client apparatus 11 is capable of sending and receiving emails.

The authentication data 35b may include a piece of information for each data set included in the data 35a regarding if the data set requires authentication for being exchanged in response to a request from the client apparatus 11. The authentication data 35b may include a piece of information regarding if the data set requires authentication for being sent, and another piece of information regarding if the data set requires authentication for being received separately.

An operation of each portion of the data exchange system will be described with reference to the drawings. An operation of each portion of the client apparatus 11 will be described with reference to FIG. 2.

After receiving an incoming radio signal sent from the network 13 via the antenna 22a and the duplexer 22b, the receiver 23b amplifies, down-converts and demodulates the received radio signal to produce one of an incoming control signal and an incoming digital signal. The receiver 23b provides the controller 21 with the incoming control signal and provides the data exchange manager 24 with the incoming digital signal.

The controller 21 provides the transmitter 23a with an outgoing control signal. The data exchange manager 24 provides the transmitter 23a with an outgoing digital signal. The transmitter 23a upconverts and amplifies a carrier frequency modulated by one of the outgoing control signal and the outgoing digital signal to produce an outgoing radio signal. The transmitter 23a provides the antenna 22a, via the duplexer 22b, with the outgoing radio signal to be emitted into the air and to the network 13.

The data exchange manager 24 manages data exchange with the server apparatus 12 according to a profile called Object Push Profile (OPP) using a protocol called Object Exchange Protocol (OBEX). The data exchange manager 24 sends a request to the server apparatus 12 for an OBEX session to be established between the client apparatus 11 and the server apparatus 12.

After the session is established, the data exchange manager 24 may send a data set included in the data 25a to the server apparatus 12, and may send a request to the server apparatus 12 for a data set included in the data 35a to be sent from the server apparatus 12. The data exchange manager may receive the data set sent from the server apparatus 12 in response to the request, and store the received data set as a member of the data 25a.

An operation of each portion of the server apparatus 12 will be described with reference to FIG. 3. After receiving an incoming radio signal sent from the network 13 via the antenna 32a and the duplexer 32b, the receiver 33b amplifies, down-converts and demodulates the received radio signal to produce one of an incoming control signal and an incoming digital signal. The receiver 33b provides the controller 31 with the incoming control signal and provides the data exchange manager 34 with the incoming digital signal.

The controller 31 provides the transmitter 33a with an outgoing control signal. The data exchange manager 34 provides the transmitter 33a with an outgoing digital signal. The transmitter 33a upconverts and amplifies a carrier frequency modulated by one of the outgoing control signal and the outgoing digital signal to produce an outgoing radio signal. The transmitter 33a provides the antenna 32a, via the duplexer 32b, with the outgoing radio signal to be emitted into the air and to the network 13.

The data exchange manager 34 manages data exchange with the client apparatus 11 according to OPP using OBEX. The data exchange manager 34 receives a request from the client apparatus 11 for an OBEX session to be established between the client apparatus 11 and the server apparatus 12. After the session is established, the data exchange manager 34 may receive a data set included in the data 25a from the client apparatus 11, and store the received data set as a member of the data 35a. The data exchange manager 34 may send a data set included in the data 35a in response to a request from the client apparatus 11.

The session history data 34b stored in the session memory 34a contains a chronologically ordered list of session cancellation events. Each entry of the session history data 34b is an event in which the data exchange manager 34 cancels an OBEX session established for a data exchange service as a data set to be exchanged requires authentication. FIG. 4 is an example of an entry of the session history data 34b, associating a client identifier 34c with a date and time of cancellation 34d and a session service 34e.

In the above example, the client identifier 34c is “CLIENT 1”, the date and time of cancellation 34d is “02 JANUARY 2005 03:04:05”, and the session service 34e is “DATA EXCHANGE”. The above example says that the data exchange manager 34 canceled an OBEX session with a client apparatus named “CLIENT 1” for a “DATA EXCHANGE” service on the date and time “02 JANUARY 2005, 03:04:05”.

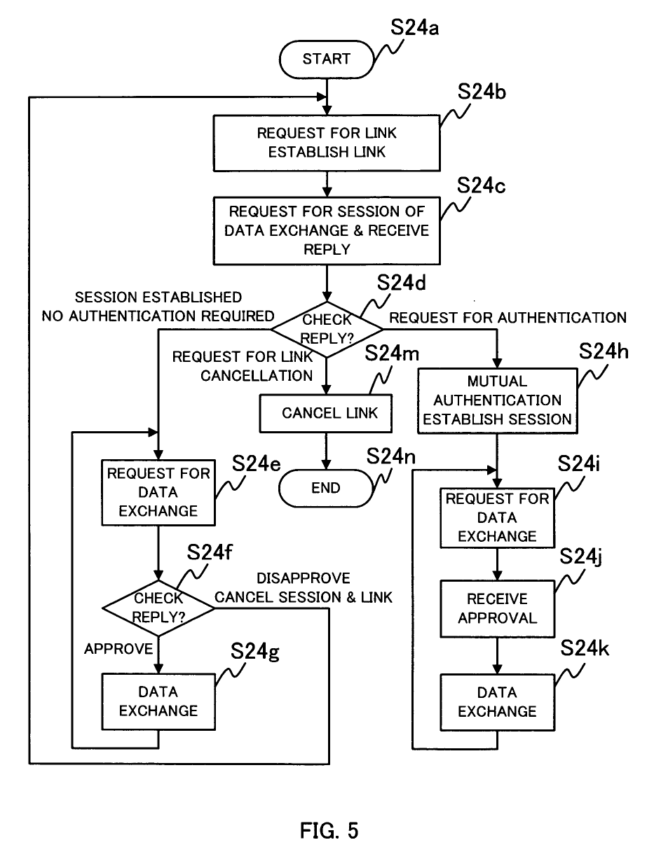

A process of data exchange between the client apparatus 11 and the server apparatus 12 of the embodiment of the present invention configured as shown above will be described hereafter. An operation flow of the data exchange manager 24 of the client apparatus 11 will be described with reference to a flow chart shown in FIG. 5.

The data exchange manager 24 starts the flow activated by the controller 21 for data exchange between the client apparatus 11 and the server apparatus 12 (step S24a). The data exchange manager 24 sends a request to the server apparatus 12 for a Bluetooth link, and establishes the Bluetooth link with the server apparatus 12 (step S24b).

The data exchange manager 24 sends a request to the server apparatus 12 for a session of data exchange based on OBEX to be established, receives a reply from the server apparatus 12 in response to the above session request (step S24c) and checks the reply (step S24d). In a case where the reply is that the session is established with no authentication, the data exchange manager 24 sends a request to the server apparatus 12 for data exchange (step S24e), and checks a reply from the server apparatus 12 in response to the above data exchange request (step S24f).

In a case where the reply checked at the step S24f gives approval, the data exchange manager 24 performs an act of data exchange with the server apparatus 12 in accordance with the request at the step S24e (step S24g). The flow then goes back to the step S24e, and the data exchange manager 24 will send another request for data exchange.

In a case where the reply checked at the step S24f gives disapproval, and the server apparatus 12 cancels the session requested at the step S24c and the Bluetooth link requested at the step S24b, the flow goes back to the step S24b and the data exchange manager 24 will send another request for a Bluetooth link to be established with the server apparatus 12.

In a case where the reply checked at the step S24d is a request for authentication, the data exchange manager 24 performs an act of mutual authentication with the server apparatus 12. After the mutual authentication, a session is established between the client apparatus 11 and the server apparatus 12 (step S24h). In a process of the mutual authentication between two parties, the one party sends an own password to the other party that checks if the password is correct, and vice versa. Something like, e.g. a device identification assigned to the client apparatus 11 may be used instead of the password.

The data exchange manager 24 sends a request to the server apparatus 12 for data exchange (step S24i). Upon receiving a reply of approval (step S24j), the data exchange manager 24 performs an act of data exchange with the server apparatus 12 in accordance with the request at the step S24i (step S24k). The flow then goes back to the step S24i, and the data exchange manager 24 will send another request for data exchange.

In a case where the reply checked at the step S24d is a request for link cancellation, the data exchange manager 24 cancels the Bluetooth link established at the step S24b (step S24m), and ends the flow (step S24n). Upon finding out that no data set should be exchanged at one of the step S24e and the step S24i, the data exchange manager 24 cancels the session requested at the step S24c, cancels the Bluetooth link requested at the step S24b and ends the flow (not shown).

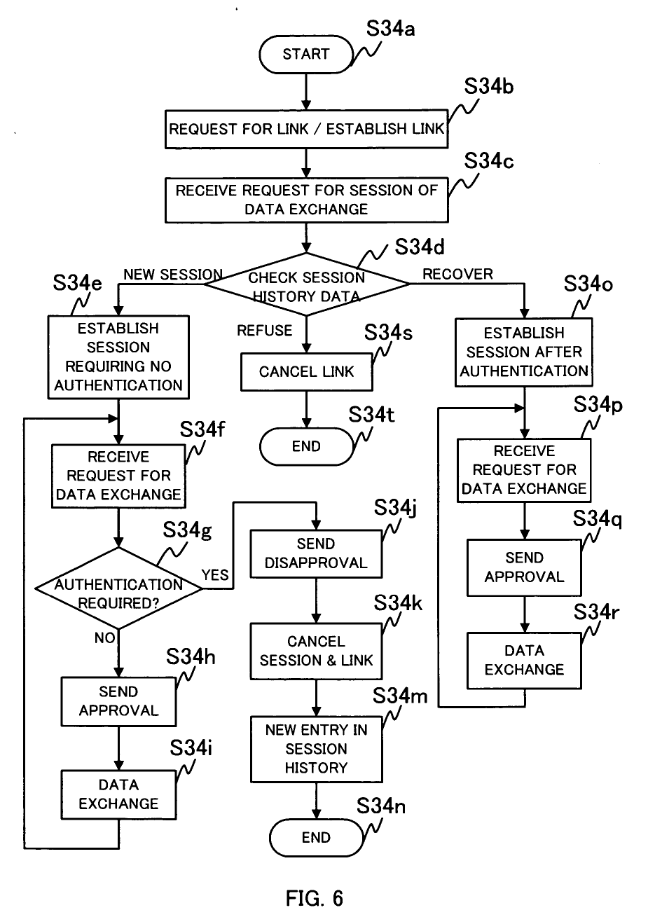

An operation flow of the data exchange manager 34 of the server apparatus 12 will be described with reference to a flow chart shown in FIG. 6. The data exchange manager 34 starts the flow activated by the controller 31 that has received a control signal sent from the client apparatus 11 (step S34a). Upon receiving a request sent from the client apparatus 11 for a Bluetooth link, the data exchange manager 34 establishes the Bluetooth link with the client apparatus 11 (step S34b).

The data exchange manager 34 receives a request from the client apparatus 11 for a session of data exchange based on OBEX to be established (step S34c). The data exchange manager 34 checks an entry of the session history data 34b regarding a previously canceled session with the client apparatus 11.

The data exchange manager 34 performs an act selected out of three possibilities based on a result of the above check in response to the above session request. The possibilities are to recover the previously canceled session, to refuse the session request, and to establish a new session bearing no relation to the previously canceled session. The flow branches into three different paths according to the above selection of the possibilities (step S34d).

Assume, firstly, that the client identifier 34c of the checked entry of the session history data 34b identifies the client apparatus 11, that the date and time of cancellation 34d of the checked entry is past but less than a given period of time ago, and that the session service 34e of the checked entry is “DATA EXCHANGE”. The checked entry on the above first assumption says that the data exchange manager 34 canceled a session with the client apparatus 11 less than a given period of time ago as a set of data to be exchanged on the session required authentication, as described later. The data exchange manager 34 then determines to recover the canceled session.

Assume, secondly, that the client identifier 34c of the checked entry of the session history data 34b identifies the client apparatus 11, that the date and time of cancellation 34d of the checked entry is past but less than a given period of time ago, and that the session service 34e of the checked entry is other than “DATA EXCHANGE”. The checked entry on the above second assumption says that the data exchange manager 34 canceled a session with the client apparatus 11 less than a given period of time ago, and that although the canceled session may be recovered from a viewpoint of the date and time of cancellation, the canceled session was of a different session service. The data exchange manager 34 then determines to refuse the session request.

Assume, thirdly, that the client identifier 34c of the checked entry of the session history data 34b does not identify the client apparatus 11. Assume, fourthly, that the client identifier 34c of the checked entry of the session history data 34b identifies the client apparatus 11, and that the date and time of cancellation 34d of the checked entry is no less than a given period of time ago. The checked entry on one of the above third assumption and the above fourth assumption says that there is no need to care about existence of a past session with the client apparatus 11 and an associated session service. The data exchange manager 34 then determines to establish a new session.

Upon determining to establish a new session at the step S34d, the data exchange manager 34 establishes a new session requiring no authentication (step S34e). The data exchange manager 34 receives a request from the client apparatus 11 for a data set included in one of the data 25a and the data 35a to be exchanged (step S34f), and determines if the data set requested above requires authentication for being exchanged with reference to the authentication data 35b (step S34g).

Upon determining that the requested data set requires no authentication at the step S34g, the data exchange manager 34 sends to the client apparatus 11 a reply of approval to the request at the step S34f, i.e. a reply of success (step S34h). The data exchange manager 34 exchanges the data set requested at the step S34f with the client apparatus 11 (step S34i). The flow then goes back to the step S34f, and the data exchange manager 34 will receive another request for data exchange.

Upon determining that the requested data set requires authentication at the step S34g, the data exchange manager 34 sends to the client apparatus 11 a reply of disapproval to the request at the step S34f, i.e. a reply of error (step S34j). The data exchange manager 34 then cancels the session established at the step S34e, and cancels the Bluetooth link established at the step S34b (step S34k).

The data exchange manager 34 puts a new entry in the session history data 34b stored in the session memory 34a, including an identification of the client apparatus 11 as the client identifier 34c, a present date and time as the date and time of cancellation 34d, and “DATA EXCHANGE” as the session service 34e (step S34m). The data exchange manager 34 then ends the flow (step S34n).

Upon determining to recover the canceled session at the step S34d, the data exchange manager 34 sends a request to the client apparatus 11 for authentication, and establishes a recovered session after a process of the mutual authentication (step S34o).

The data exchange manager 34 receives a request from the client apparatus 11 for a data set included in one of the data 25a and the data 35a to be exchanged (step S34p). The data exchange manager sends to the client apparatus 11 a reply of approval without determining if the data set requested above requires authentication, as the session has been established after authentication at the step S34o (step S34q). The data exchange manager 34 exchanges the data set requested at the step S34p with the client apparatus 11 (step S34r), and will receive another request for data exchange at the step S34p.

In a case where the session established at the step S34e is canceled by the client apparatus 11 at any of the above steps, and a case where the Bluetooth link established at the step S34b is canceled by the client apparatus 11 at any of the above steps, the data exchange manager 34 ends the flow (not shown).

The data exchange manager 34 may determine whether to send a request for authentication of an OBEX session before establishing the Bluetooth link at the step 34b, according to if the session history data 34b includes an entry where the date and time of cancellation 34d is less than a given time ago and if the canceled session may be recovered.

Upon determining to refuse the session request at the step S34d, the data exchange manager 34 cancels the Bluetooth link established at the step S34b (step S34s) and ends the flow (step S34t).

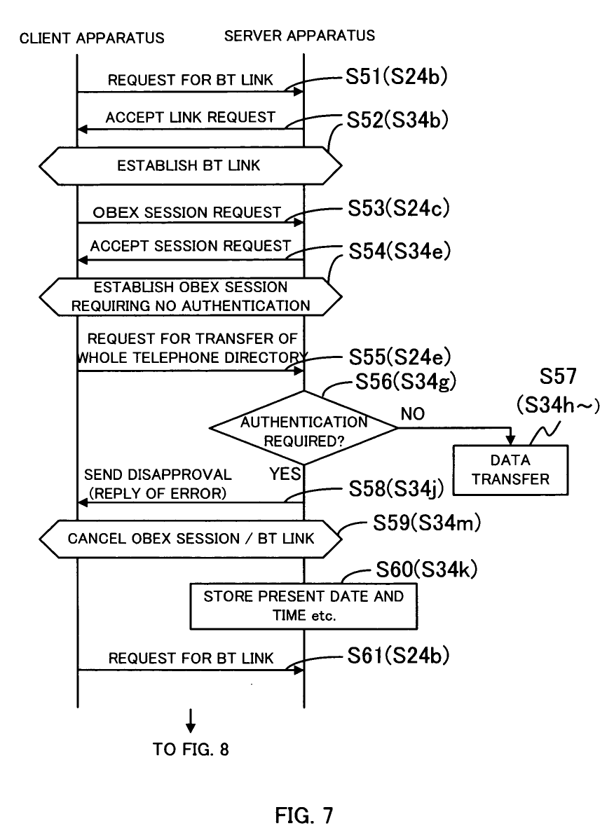

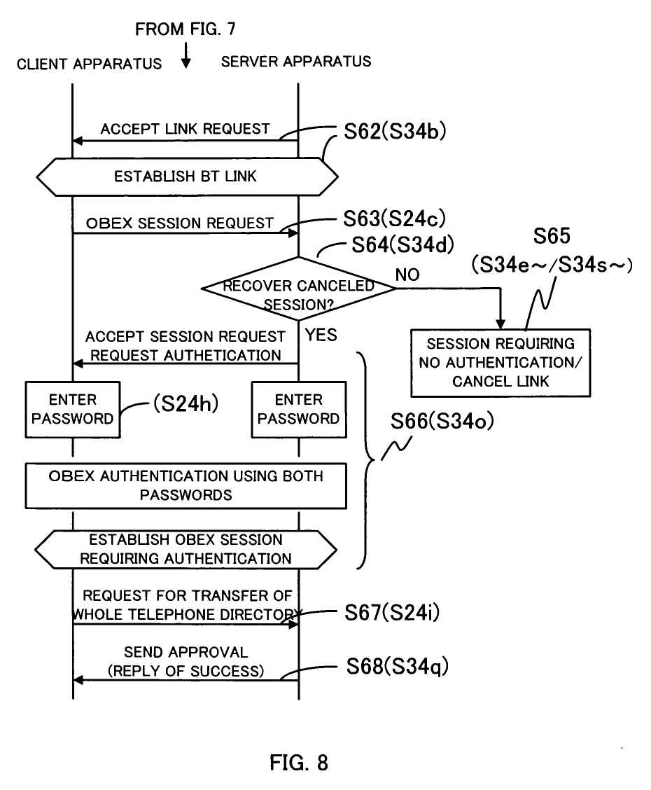

An example of data exchange sequence between the client apparatus 11 and the server apparatus 12 will be described with reference to FIG. 7 and FIG. 8. In this example, it is assumed that the client apparatus 11 transfers a whole telephone directory, a data set included in the data 25a, to the server apparatus 12. It is also assumed that the authentication data 35b indicates that a process of receiving and storing a whole telephone directory in the data memory 35 as a member of the data 35a requires authentication.

Each step of the sequence shown in FIG. 7 and FIG. 8 is given a reference step numeral of a corresponding step shown in either FIG. 5 or FIG. 6 for better understanding and simplicity, although a step of a transaction between the client apparatus 11 and the server apparatus 12 corresponds to both FIG. 5 and FIG. 6.

The sequence starts with a request from the data exchange manager of the client apparatus 11 for a Bluetooth link (step S51, i.e. the step S24b in FIG. 5). In response to the above link request, the data exchange manager 34 of the server apparatus 12 sends a reply to accept the link request, and establishes a Bluetooth link (step S52, i.e. the step S34b in FIG. 6).

The data exchange manager 24 sends a request for an OBEX session (step S53, i.e. the step S24c in FIG. 5). Assume, at the step S53, that the session history data 34b has no entry. In response to the above session request, the data exchange manager 34 sends a reply to accept the session request, and establishes an OBEX session (step S54, i.e. the step S34e in FIG. 6).

Assume that the session history data 34b has no entry at the step S53 as there has been no transaction between the client apparatus 11 and the server apparatus 12, and that the data exchange manager 34 determines to establish a new session at the step S34d in FIG. 6.

The data exchange manager 24 sends a request for a transfer of the whole telephone directory included in the data 25a (step S55, i.e. the step S24e in FIG. 5). Upon receiving the above transfer request, the data exchange manager 34 determines if the whole telephone directory requires authentication for being exchanged with reference to the authentication data 35b (step S56, i.e. the step S34g in FIG. 6).

At the step S56, a data set requiring no authentication for being exchanged (i.e. other than the whole telephone directory) would be transferred from the client apparatus 11 to the server apparatus 12 and stored in the data memory 35 as a member of the data 35a (step S57, i.e. the step S34h and S34i in FIG. 6).

As the whole telephone directory requires authentication for being transferred and stored in the data memory 35 as a member of the data 35a, the data exchange manager 34 sends a reply of disapproval in response to the transfer request (step S58, i.e. the step S34j in FIG. 6). The data exchange manager 34 then cancels the Bluetooth link and the OBEX session (step S59, i.e. the step S34k in FIG. 6).

The data exchange manager 34 puts a new entry in the session history data 34b stored in the session memory 34a, including an identification of the client apparatus 11 as the client identifier 34c, a present date and time as the date and time of cancellation 34d, and “DATA EXCHANGE” as the session service 34e (step S60, i.e. the step S34m in FIG. 6). The data exchange manager 24 sends another request for a Bluetooth link (step S61, i.e. step S24b in FIG. 5).

The sequence then moves into FIG. 8. The data exchange manager 34 sends a reply to accept the above link request, and establishes a new Bluetooth link (step S62, i.e. the step S34b in FIG. 6). The data exchange manager 24 sends another request for an OBEX session (step S63, i.e. the step S24c in FIG. 5). Upon receiving the above session request, the data exchange manager 34 checks if a canceled session may be recovered in response to the session request with reference to the date and time of cancellation 34d (step S64, i.e. the step S34d in FIG. 5).

In a case where no canceled session may be recovered, the data exchange manager 34 may establish a session requiring no authentication (step S65, i.e. the step S34e and the following steps in FIG. 5), and may cancel the Bluetooth link (step S65, i.e. the step S34s and the following steps in FIG. 6).

In a case where the canceled session is recovered in response to the session request, the data exchange manager 34 sends a request for authentication. After the above authentication request, a password of the client apparatus 11 is entered into the client apparatus 11, and a password of the server apparatus 12 is entered into the server apparatus 12. Each of the passwords may be entered through an input device. Each of the passwords may be read out of the memory 25 and the data memory 35, respectively, and then entered.

The data exchange manager 24 and the data exchange manager 34 perform an act of the mutual authentication using the passwords, and establish an OBEX session requiring authentication (step S66, i.e. the step S24h in FIG. 5 between the authentication request and the session establishment, the step 34o in FIG. 6).

The data exchange manager 24 sends a request for a transfer of the whole telephone directory included in the data 25a (step S67, i.e. the step S24e in FIG. 5). Upon receiving the above transfer request, the data exchange manager 34 sends a reply of approval, i.e. a reply of success (step S68, i.e. the step S34q in FIG. 6). The whole telephone directory is then transferred.

The controller 21 of the client apparatus 11 exchanges a data set included in the data 25a with the server apparatus 12 based on, but not limited to, a plurality of instructions entered from the input device. The controller 21 may exchange a data set included in the data 25a with the server apparatus 12 on a constant time interval basis.

A data set included in one of the data 25a and the data 35a is not limited to a telephone directory and an email folder, but may be of any kind of data like pictures, music and videos. The present invention may be applied to a mobile phone, a personal digital assistant, a personal computer and a home appliance having communication capabilities.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A client apparatus, comprising:
a transmitter configured to send a plurality of outgoing data via a communication network;
a receiver configured to receive a plurality of incoming data via the communication network;
a memory configured to store a plurality of data to be exchanged with a server apparatus via the communication network; and
a data exchange manager connected to the transmitter, the receiver and the memory, and configured
to establish a first session with the server apparatus in a case where a request for the first session sent to the server apparatus is approved without authentication,
to establish a second session after authenticating the server apparatus and being authenticated by the server apparatus in a case where the server apparatus requests authentication in response to the first request, and
to exchange with the server apparatus on the first session a set of data requested after the first session is established and requiring no authentication for being exchanged, and
to exchange with the server apparatus on the second session a set of data requested after the second session is established.

2. The communication apparatus of claim 1, wherein the data exchange manager is further configured to cancel the first session in a case where a request for data exchange on the first session is disapproved by the server apparatus.

3. A server apparatus, comprising:
a transmitter configured to send a plurality of outgoing data via a communication network;
a receiver configured to receive a plurality of incoming data via the communication network;
a first memory configured to store a plurality of data to be exchanged with a server apparatus via the communication network;
a second memory configured to store a record of a past session with the client apparatus;
a data exchange manager connected to the transmitter, the receiver, the first memory and the second memory, and configured
to establish a first session with the client apparatus without authentication after approving a request for the first session as the second memory stores at most a record of a past session with the client apparatus canceled no less than a given time ago,
to establish a second session after authenticating the client apparatus and being authenticated by the client apparatus after requesting authentication in response to the first request, as the second memory stores a record of a past session with the client apparatus canceled less than the given time ago, and
to exchange with the client apparatus on the first session a set of data requested after the first session is established and requiring no authentication for being exchanged, and
to exchange with the client apparatus on the second session a set of data requested after the second session is established.

4. The server apparatus of claim 3, wherein the data exchange manager is further configured to disapprove a request for a set of data to be exchanged on the first session in a case where the set of data requires authentication for being exchanged.

5. A data exchange system, comprising:
a client apparatus; and
a server apparatus, both configured
to exchange a plurality of data to each other via a communication network,
to establish a first session between each other without authentication in a case where the server apparatus approves a request for the first session sent from the client apparatus, as the server apparatus stores at most a record of a session with the client apparatus canceled no less than a given time ago,
to establish a second session between each other after authenticating each other in a case where the server apparatus requests authentication in response to the request for the first session, as the server apparatus stores a record of a session with the client apparatus canceled less than a given time ago,
to exchange between each other on the first session a set of data requested after the first session is established and requiring no authentication for being exchanged, and
to exchange between each other on the second session a set of data requested after the second session is established.

6. The data exchange system of claim 5, wherein the client apparatus and the server apparatus are further configured to cancel the first session in a case where a request from the client apparatus for a set of data to be exchanged on the first session is disapproved by the server apparatus, as the set of data requires authentication for being exchanged.
